(19) United States
(12) Patent Application Publication
(10) Pub. No.: US 2022/0016713 A1
(43) Pub. Date: Jan. 20, 2022

(54) Device and method for (ultra-high-speed) laser cladding

(71) Applicant: Ponticon GmbH, Wiesbaden (DE)

(72) Inventor: Oliver Schulte, Stadecken-Elsheim (DE)

(21) Appl. No.: 17/253,157

(22) PCT Filed: Jun. 19, 2019
(86) PCT No.: PCT/EP2019/066193

§ 371 Date: Jun. 15, 2021

(30) Foreign Application Priority Data
Jun. 20, 2018 (DE) 10 2018 114 883.6

(51) Int. Cl. B22F 12/33; B23K 26/342; B23K 26/08; B22F 10/28; B33Y 10/00; B33Y 30/00

(52) U.S. Cl. CPC B22F 12/33; B23K 26/342; B23K 26/0884; B33Y 30/00; B22F 10/28; B33Y 10/00; B23K 26/0861

(57) ABSTRACT

A device, and method, for laser cladding, in particular for extreme-high-speed-laser cladding (EHLA), comprising: at least three drive columns; a workpiece support for a product to be manufactured, the support being positioned centrally between the drive columns, and/or a support plate for a welding head, which is movably connected to the drive columns in three spatial directions (x, y, z) via multiple tension-compression struts and revolute joints that are fixed on the ends thereof, wherein, each drive column has at least one inner guide rail facing the workpiece support and/or the support plate with an inner carriage running in said rail for moving the workpiece support and/or the support plate in the three spatial directions and has an outer guide rail with an outer carriage running therein for guiding a counterweight vertically in the opposite direction to the inner carriage; and a welding head.

### TECHNICAL FIELD

The present invention is in the field of laser cladding and relates to a device and method for laser cladding, in particular for carrying out extreme-high-speed laser cladding (German acronym: EHLA).

### BACKGROUND ART

Laser cladding in the conventional processes (for example LMD=Laser Metal Deposition) is used for surface treatment, repair and additive manufacturing of components. In this process, a powdered filler material, for example a metal powder, is introduced into the interaction zone of the laser beam with the base material by means of a powder feed nozzle and melted there with a laser beam to form a composite.

In a variant of laser cladding, in extreme-high-speed laser cladding (EHLA), the powdered filler material is melted by the laser beam before it enters the molten pool generated by the laser beam. This allows very high traversing speeds of up to 500 m/min or more to be realized and layer thicknesses in the range of 10-250 μm per layer to be produced. Such a method is, for example, part of DE 10 2011 100 456 B4. In said method, at least one additive material in completely molten form is added to a molten bath present on a surface to be processed. For this purpose, the filler material, which is initially presented in powder form, is melted by means of a laser beam at a distance greater than zero from the melt pool and then added to the melt pool in liquid form. In doing so, the workpiece surface can be moved relative to the laser beam and the powder gas jet so that the molten bath moves across the surface. This process allows particularly high speeds of workpiece movement of more than 50 m/min. Three-dimensional structures can be built up additively by superimposing individual layers. Such structures can be built either on existing components or, when generating entire objects, on a workpiece carrier plate which then serves as the base.

In order to achieve such high process speeds, high standards are required regarding the process technology as well as regarding the kinematics of the devices used for this purpose. For example, the powder supply to the powder nozzle must be designed in such a way that the introduction of the powder into the laser beam is optimal and the powder efficiency is maximized. Such solutions are described for example in DE 10 2014 220 183 A1, which describes a laser beam arrangement that can generate several individual laser beams to achieve a high powder efficiency. The disadvantage, however, is that the individual laser beam sources must be coordinated in order to hit the powder in a focused manner, which is very costly. A nozzle for laser cladding is described in EP 2 774 714 A1, for example, which ensures the defined feed of the powder into the laser beam.

The extremely fast movement of the welding head and/or the workpiece support is also critical. In machine tools, product carriers for machining a material are often used, which are called tripod or hexapod. Such devices are for example part of DE 196 40 769 A1, U.S. Pat. No. 5,401,128 or DE 199 03 613 C1. Solutions for a hexapod are also part of U.S. Pat. No. 6,196,081 B1 and DE 10 2010 025 275 B4. However, these devices are only conditionally or not at all suitable for use in extreme-high-speed laser cladding (EHLA) as they are not designed for precision at high accelerations or decelerations.

US 2017/0282297 A1 describes a device for moving a nozzle along the x, y and z coordinates, consisting of a tripod and suspensions for a nozzle unit. Five actuators are required for the movement. However, the workpiece itself is not moved and remains fixed.

DE 33 19 665 A1 describes a device for linear movement of spraying elements with a counterweight. This requires a spring pre-tensioned deflection roller, which, however, prevents high dynamics. However, the use of springs for energy storage at defined reversal points and the limit switches arranged there only allow a fixed preset working stroke at low speed. Such a device would not be suitable for the EHLA method.

The same applies to the device described in CN 105 499 796 A, in which the working head is also guided while the product carrier plate is fixed. Vertical acceleration forces are not compensated either. The same applies to the variant in CN 105 773 984 A, a tripod device for 3D printing.

### DISCLOSURE OF INVENTION

Therefore, it is the objective of the present invention to provide a device and a method for laser cladding, in particular for extreme-high-speed laser cladding, with which high traversing speeds of up to 500 m/min are possible with high path accuracy and repeatability.

This objective is solved by a device and a method according to the invention, as claimed in the following patent claims. Preferred embodiments are represented in the sub-claims.

The device according to the invention allows a relative speed between welding head and workpiece support of more than 50 m/min for layer thicknesses usually from 0.01 mm to 0.25 mm when using the EHLA method and higher layer thicknesses when using other deposition welding heads. Depending on the dynamics, the type of contour to be built up and the process parameters, path accuracies of better than 0.01 mm are achieved. The device must be designed so that, for example, accelerations of the welding head can be set below the maximum permissible acceleration. Such mechanics can be achieved by the inventive design and in particular by the novel suspension of the workpiece support, respectively of the support for the welding head in the device.

For this purpose, the device according to the invention comprises at least three drive columns with—depending on the embodiment—a workpiece support arranged centrally between the drive columns for receiving the product to be manufactured or processed and/or a support plate for the welding head. The workpiece support has a receiving area for receiving a product to be manufactured or processed. Several tension-compression struts are arranged on the workpiece support and/or the support plate in an isosceles arrangement, at least one tension-compression strut being provided per drive column, preferably a pair of tension-compression struts per suspension point. The workpiece support and/or the support plate are connected via the tension-compression struts so that they can move in the three spatial directions (x, y, z). For this purpose revolute joints are provided at the ends of the tension-compression struts, which couple the struts with the workpiece support or support plate at one end and the drive column at the other end. Each drive column comprises at least one inner guide rail facing the workpiece support and/or the support plate with an inner carriage guided therein for carrying out movements in the three spatial directions (x, y, z), preferably path movements of the workpiece support and/or the support plate. For this purpose the inner carriage is guided along the inner guide rail, preferably vertically upwards or downwards. Furthermore, the device also includes the welding head, for example the laser head with powder feed nozzle for introducing the filler material into the molten bath. Instead of a powder feed nozzle, it is also possible to use a wire feed nozzle.

The term “upper” used here refers to the head side of the respective component or the entire device when viewed from the front, the term “lower” refers to its foot side. The terms “inner” and “outer” indicate the position of the component relative to the product to be manufactured. Thus, the inner guide rail faces the product, while the outer guide rail is formed on the side of the drive column facing away from the product. The inner guide rail and the outer guide rail are preferably mounted opposite each other on the drive column.

The term “workpiece support” refers to the component which holds the product to be manufactured or processed. The term “support plate” refers to the component which holds the welding head, i.e. preferably the laser head.

According to the invention, an outer carriage is guided in the outer guide rail to guide a counterweight vertically opposite the inner carriage. The counterweight provides for the mass compensation occurring for example in the EHLA method at speeds of >200 m/min, preferably 500 m/min or more, and accelerations of 50 m/s² or more. This is because at these high traversing speeds, high pulses are generated by the moving masses. These pulses can influence the environment of the device and lead to undesired disturbances during laser application. The horizontal mass movements can be at least partially absorbed by the counterweights and the interaction of the individual drive columns. Therefore, the solution according to the invention provides for a separation of the drive systems, which allows an almost complete compensation of the vertical mass movement.

The welding head is preferably arranged parallel to the workpiece support, preferably above the workpiece support. It is preferably a laser welding head or a soldering head.

In one variant of the device, three drive columns are provided, in which the tension-compression struts are connected from above via revolute joints to the head side of the workpiece support and/or support plate and the drive columns. The axis end points and thus suspensions are preferably arranged according to an isosceles triangle on the workpiece support or the support plate, whereby they hold the workpiece support or the support plate without inclination and the workpiece support or the support plate can be moved in the horizontal plane (x, y) and in the vertical direction (z) or in a combination of the three spatial directions. Preferably, this variant is a tripod.

The carriages are preferably driven by highly dynamic linear direct drives. DE 203 06 233 U1 describes such a principle of linear guidance for powder spray guns. This drive variant enables very high accelerations to achieve speeds of over 5 m/s at almost any stroke. Of course, other drive concepts are also possible to perform a path movement of the workpiece support and/or the support plate. The path movement of the workpiece support or support plate is preferably a movement along the x, y, z spatial axes, preferably executed as a synchronous movement of three axes.

It is preferably provided that the tension-compression struts are not adjustable in their length in order to ensure efficient energy chain guidance and to avoid uncontrolled vibrations of the workpiece support or of the support plate for the welding head.

The workpiece support and/or support plate is preferably suspended at six points. This means that one pair of tension-compression struts is provided at each suspension point, which in turn is connected to a carriage of a drive column. Preferably, the workpiece support and/or support plate is suspended at six points via in each case two parallel tension-compression struts of equal length, whereby in each case two tension-compression struts being connected to in each case one carriage of a drive column. This prevents the workpiece support or support plate from being rotated out of the horizontal position.

In a further developed embodiment, a six-axes geometry is provided, in which each individual tension-compression strut is connected to its own inner carriage (hexapod). Accordingly, each drive column comprises a carriage connected to a tension-compression strut with a corresponding guide rail for vertical guidance of the carriage and inclination of the workpiece support or support plate. This allows the workpiece support or support plate to be inclined at an angle of preferably up to 80°.

Preferably, the vertical guidance of the carriages, i.e. the inner carriage facing the product and the outer carriage running on the back of the drive column, is carried out via idlers mounted on the head side or foot side of each drive column. The vertical guidance of the carriages is provided by a drive belt, preferably a toothed belt. Preferably, a drive belt clamping is provided for the drive belt. In this embodiment, preferably, each individual tension-compression strut with its own carriage independently vertically movable within its own guide rail of a drive column is individually movable in the vertical direction.

The welding head is preferably held by the support plate, which is arranged parallel to the workpiece support, preferably above or below the workpiece support. In an advanced embodiment, a wobble plate is suspended between the support plate and the workpiece support, which enables the welding head to be offset in its axis. This enables the production of different components and a high adaptability of the device to the individual production specifications. With the help of this low-inertia wobble device, corrections can be made particularly to the relative or absolute path movement inaccuracies of the laser head, which are caused by the inertia between the control and drive elements. In addition, the wobble plate enables small partial movements, e.g. tight curve radii, when contouring or generating compact welding structures. This can relieve the main movement apparatus and increase the speed of the entire system.

In a basic version, the welding head (i.e. the laser head) is fixed to a suspension above the workpiece support. However, due to the construction of larger structures in a product to be manufactured, the center of gravity of the workpiece support can shift considerably, which would require a reduction in the speed and/or acceleration of the workpiece support. To avoid this, preferably, a coupling system for the welding head is provided on the workpiece support, which is preferably automated. This is preferably a three-point coupling, with which the welding head can be taken over from the workpiece support.

Furthermore, the wobble plate enables the production of contours or curves, which are normally created by generating small segments in the three spatial directions (x, y, z) through the main axes. However, dividing a curve into very small curve segments means constant course corrections with constantly new transverse accelerations. Due to mechanical inertia, the main axes cannot complete a given set before a new motion set is transmitted by the controller. In high-speed processes, therefore, radii will be shifted towards the inside of the curve as the path speed increases. Circular paths then have a smaller diameter. This leads to overgrinding and to a path deviation.

In this version, the wobble plate according to the invention enables compensation for overgrinding by allowing an axial offset of the welding head of approx. 1°-5°, preferably 1°-3°.

Preferably, the support plate is suspended from a top plate by means of an upper coupling socket gripping from above and a lower coupling socket gripping from below by means of corresponding fixtures. Preferably the wobble plate is connected to the support plate via suspensions in order to achieve the required axis offset.

In a further embodiment, it is provided that a support plate for the welding head is arranged above the workpiece support, each of which is suspended by its own tension-compression struts. Each plate has its own carriage, which can be moved vertically in a common guide of a drive column. In this variant, both the workpiece support and the welding head can be adjusted via the support plate, since the tension-compression struts with revolute joints attached to their ends allow the support plate or the workpiece support to be moved in the three spatial directions (x, y, z). Basically, the tension-compression struts can be coupled to the workpiece support or the support plates either on their side, on their top or on their bottom. In a preferred embodiment, it is provided that the coupling of the tension-compression struts to the workpiece support for the product takes place from the side, while the coupling of the tension-compression struts to the support plate for the welding head takes place from above. Depending on the type of production, other embodiments are also conceivable.

In a variant, both the support plate and the workpiece support can be moved individually in the three x, y, z spatial directions. In a further, preferred embodiment, the support plate is designed to be immovable and the workpiece support can be moved axially in the three x, y, z spatial directions.

Preferably, in a further embodiment, a pivot and rotation device is provided for the product to be manufactured to enable synchronous counter-rotating movements of independent axis systems at high movement speed of the axis system not guiding the laser head. The pivot device is arranged below the workpiece support and allows the product to be tilted and/or rotated

The invention also relates to a method for laser cladding, in which a workpiece support for a product to be manufactured is moved via at least three drive columns in three spatial directions (x, y, z) along a welding head arranged parallel to the workpiece support, said drive columns each permitting a path movement (i.e. a synchronous movement of three axes) of the workpiece support via associated tension-compression struts and a mass compensation by means of corresponding counterweights. In the method, a powdered filler material is injected through a powder nozzle into the molten bath generated by the laser beam on the component surface and melted. This creates a thin layer on the component. In the EHLA method, the powdered filler material is injected into the laser beam and melted there before the powder reaches the molten bath. It is the aim to produce a powder gas jet that is as dense and homogeneous as possible with a high degree of powder utilization. As a result, thin layers can be applied to components with high accuracy at high processing speeds, for example for parts for the automotive or aviation industry. In the basic version of the device according to the invention three actuators are sufficient.

The method according to the invention is used to manufacture a product or workpiece to be manufactured.

Different nozzles can be used in the method according to the invention. Examples are various powder cone nozzles, hybrid processing nozzles or multi-jet nozzles.

In the method according to the invention, preferably welding nozzles are used, such as powder feed nozzles or wire feed nozzles.

After cutting with a laser cutting head, it is also possible to treat the workpiece with a milling head at a later stage. In a preferred embodiment, the device and method according to the invention therefore include a milling head that can be moved along the axis. This milling head can also be connected in series with the welding head.

In a further preferred embodiment, a subsequent optional coating of the workpiece is also provided after laser processing and/or milling.

In a further embodiment, oscillating operation is used to design curves and cavities in the workpiece, i.e. the material is not applied continuously but with a time delay according to the structure of the workpiece. Preferably, the welding head is guided horizontally, vertically or diagonally, to form for example a curved or web-shaped structure. In this way, highly structured housings of automatic and manual gearboxes, nozzles of rocket motors, complex fixtures or axis systems or filling structures of massive bodies can be produced.

The method according to the invention may also use amorphous material compositions, such as crystalline solids, amorphous solids or mixtures thereof. Amorphous materials usually consist of the same material as crystalline solids. They differ, however, in their lattice alignment during cooling. Amorphous solids are formed when the material cools down so quickly that the atoms can no longer align themselves. Thus it is possible to produce sandwich materials such as tool steel with bronze coating for mold making, aluminum/stainless steel coatings for aviation or titanium-steel structures as tool armoring in the glass industry. In addition, mixed material compositions can be realized, such as tungsten carbide matrix on grey cast iron for use in brake discs or for diamond-like-carbon tool coating.

### SHORT DESCRIPTION OF THE DRAWINGS

The invention is explained in more detail in the following drawings, wherein:

FIG. 1 shows a first embodiment of the device in the form of a tripod,

FIG. 2 shows another embodiment of the device in the form of a hexapod,

FIG. 3 shows a more advanced version with a wobble plate,

FIG. 4 shows a detailed representation of the wobble plate including the suspension of the welding head,

FIG. 5 shows a combined axis system for a movable workpiece support and a movable support plate,

FIG. 6 shows an alternative axis system for a movable workpiece support and a movable support plate,

FIG. 7 shows a combined solution with additional rotation and pivot device.

### WAYS OF CARRYING OUT THE INVENTION

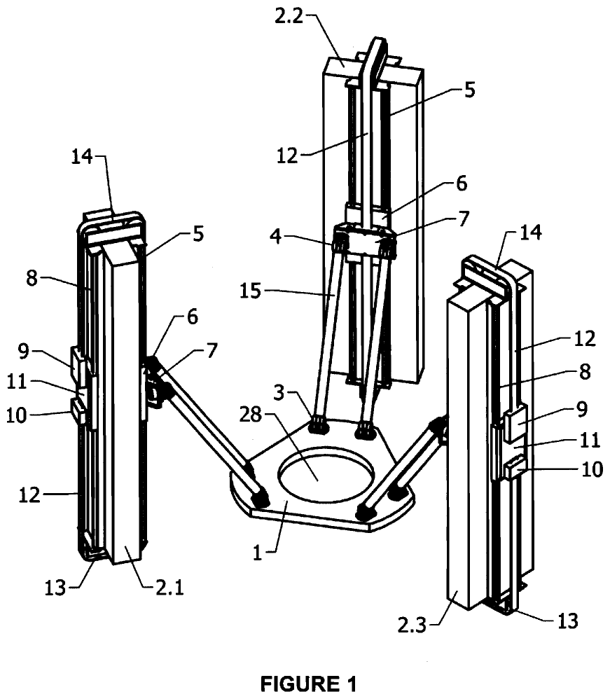

FIG. 1 shows a first embodiment of an EHLA device with a workpiece support 1 for the product to be manufactured or processed and a central product receiver 28 for processing or manufacturing the product using the laser cladding method. The workpiece support 1 is suspended at six different points via tension-compression struts 15. Each tension-compression strut 15 is connected to a lower revolute joint 3 which is connected to the workpiece support 1 and to an upper revolute joint 4 which is coupled to a carriage 6. The workpiece support 1 is centrally arranged between three drive columns (2.1, 2.2, 2.3) and can be moved via the carriages 6 along one or more of the spatial directions x, y and/or z. A carriage 6 is moved vertically along inner guide rails 5, which are facing the workpiece support 1, in order to facilitate a path movement of the workpiece support 1 (or in another embodiment the support plate 20).

The carriage 6 is connected to a drive belt clamping 7, which in turn couples the tension-compression struts 15 via the revolute joints 4. The vertical movement of the inner carriage 6 is effected by a drive belt 12, preferably a toothed belt. At the back of each drive column 2 (i.e. opposite the inner guide rail 5) there is an outer guide rail 8 in which an outer carriage 11 is guided. In addition, a counter weight 9 is provided for mass compensation. The outer carriage 11 also has a drive belt clamping 10. For guiding the drive belt 12, two idlers 13, 14 are provided at the top and bottom of each drive column. The tension-compression struts 15 hold the workpiece support 1 from above.

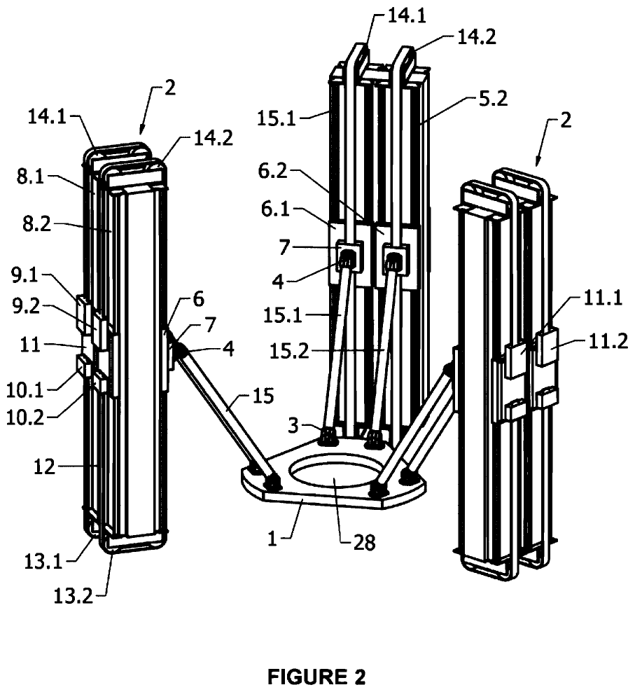

In FIG. 2 a more advanced embodiment is provided, wherein each individual tension-compression strut 15.1, 15.2 etc. of a drive column 2.1, 2.2 etc. runs in its own guide rail 5.1, 5.2 etc. via carriages 6.1, 6.2 etc. In this variant, each individual tension-compression strut 15.1, 15.2 etc. can be moved individually. Each axis has its own counterweights 9.1, 9.2 etc., which are guided vertically by their own carriages 11.1, 11.2 etc. in the opposite direction to the inner carriages 6.1, 6.2 etc. Here again the workpiece support 1 is suspended from above via the tension-compression struts 15.

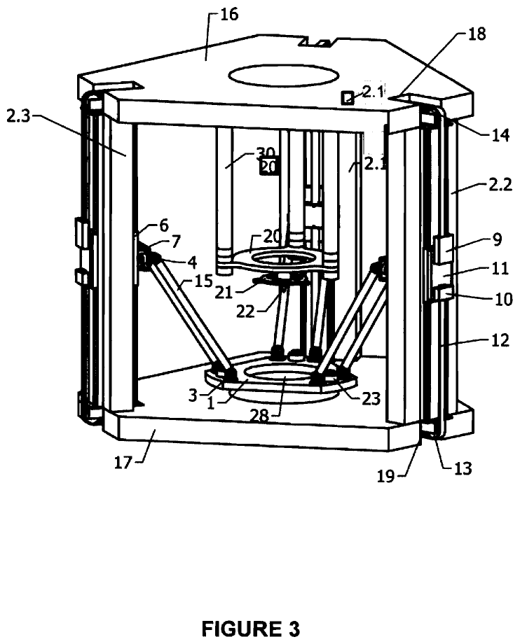

In FIG. 3 the three drive columns 2.1, 2.2, 2.3 are held by a base plate 17 and a top plate 16. The support plate 20 for the welding head 22 is held by fixtures 30 which are connected to the top plate 16. Additionally a wobble plate 21 is provided to allow an axial offset of the welding head 22.

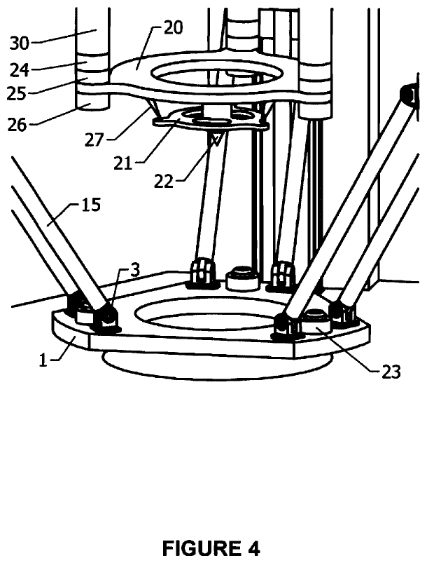

In FIG. 4 the structure of the wobble plate/construction is shown in more detail. The support plate 20 for the welding head 22 is held on the fixture 30 by an upper coupling socket 24, an upper coupling pin 25 and a lower coupling socket 26. The workpiece support 1 for the product to be manufactured also includes lower coupling pins 23, which are arranged between two tension-compression struts 15 on the surface of the workpiece support 1. The wobble plate 21 is connected to the support plate 20 via suspension 27. This allows an axial offset of 1°-3°.

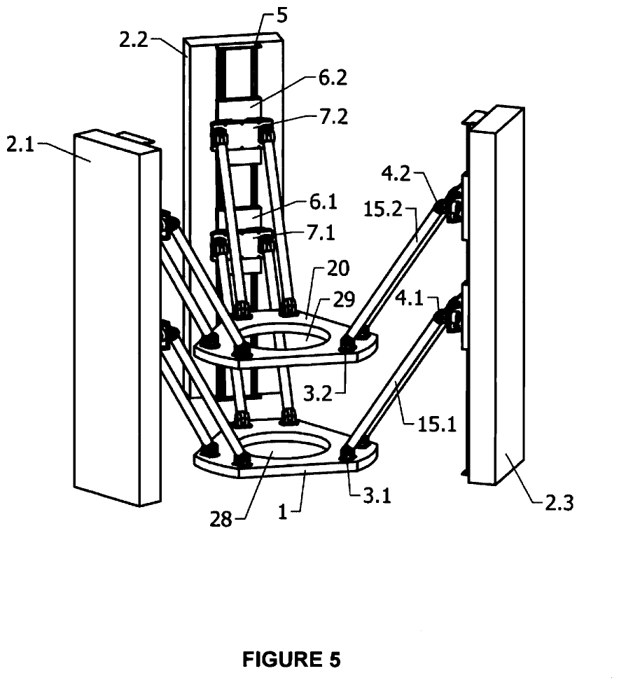

FIG. 5 shows a further embodiment, which comprises both a support plate 20 with a welding head 22 and a workpiece support 1 for a product to be manufactured or processed. In this variant, tension-compression struts 15 are connected from above to said workpiece support 1 and support plate 20 at six defined suspension points. According to the invention, it is now provided that the upper support plate 20 can be moved in three spatial directions by its own carriages 6.2. Thereby, the carriage 6.1 of the workpiece support 1 and the carriage 6.2 of the support plate 20 run in the same guide rail 5 of a drive column 2.1, 2.2 and 2.3 respectively.

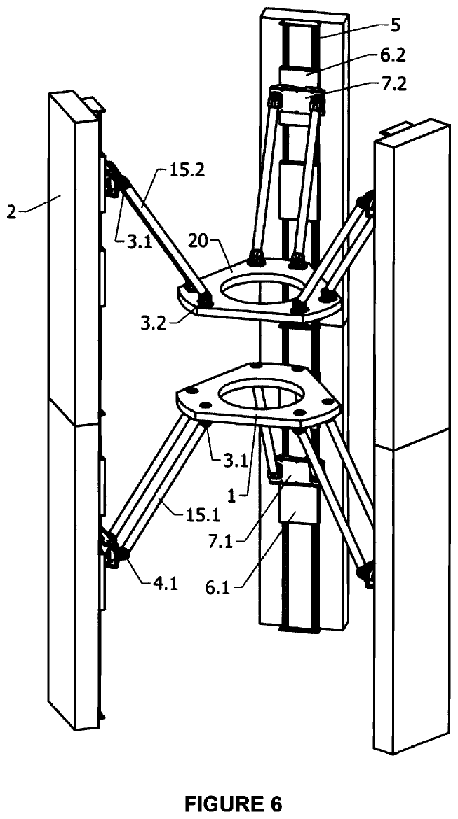

FIG. 6 shows a modification of the embodiment shown in FIG. 5, wherein the tension-compression struts 15 are coupled to the workpiece support 1 from below. Here again the individual tension-compression struts 15.1, 15.2 etc. for the workpiece support 1 and the support plate 20 can be moved individually in three spatial directions.

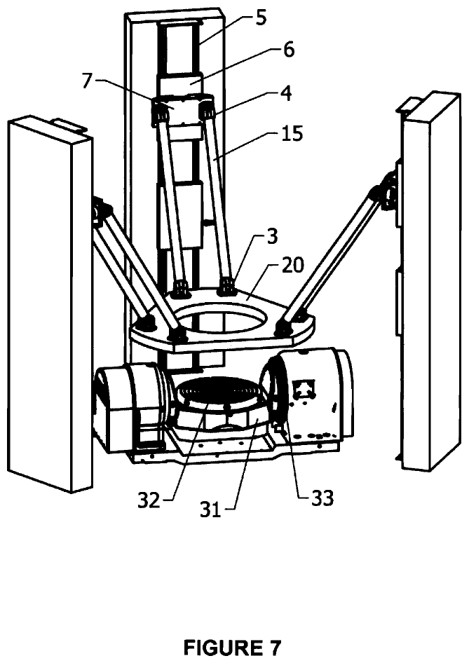

FIG. 7 shows an embodiment with an additional rotation and pivot device. This comprises a pivot device 31 and a revolute joint 33 for tilting and rotating a product receiving area 32 for the product to be produced or processed.

With the devices and methods according to the invention, speeds of >200 m/min, but preferably up to 1,000 m/min and accelerations of up to 100 m/s² can be achieved for carrying out an EHLA application process. In doing so, high accuracies are achieved with low coating thicknesses.

### REFERENCE NUMBERS

1 workpiece support
2 drive column
3 lower revolute joint (product plate)
4 upper revolute joint (drive column)
5 inner guide rail
6 inner carriage
7 drive belt clamping
8 outer guide rail
9 counter weight
10 drive belt clamping
11 outer carriage
12 drive belt
13 upper idler for drive belt
14 lower idler for drive belt
15 tension-compression struts
16 top plate
17 base plate
18 upper mount for drive column
19 lower mount for drive column
20 support plate
21 wobble plate
22 welding head
23 lower coupling pin
24 upper coupling socket
25 upper coupling pin
26 lower coupling socket
27 suspension
28 product receiver
29 opening for welding head
30 fixture
31 pivot device
32 product receiving area
33 revolute joint

1. A device for laser cladding, comprising:
at least three drive columns,
a workpiece support for a product to be manufactured, which is positioned centrally between the drive columns, and/or a support plate for a welding head, which
is movably connected to the drive columns in three spatial directions (x, y, z) via multiple tension-compression struts and revolute joints that are fixed on the ends thereof, wherein
each drive column has at least one inner guide rail facing the workpiece support and/or the support plate with an inner carriage running in said rail for moving the workpiece support and/or the support plate in the three spatial directions (x, y, z) and has an outer guide rail with an outer carriage running therein for guiding a counterweight vertically in the opposite direction to the inner carriage, and
a welding head.

2. The device according to claim 1, wherein the workpiece support and/or the support plate are suspended at six points via in each case two parallel tension-compression struts of equal length, in each case two tension-compression struts being connected to in each case one inner carriage of a drive column.

3. The device according to claim 1 wherein the guidance of the carriages takes place via idlers for drive belts provided on the drive columns.

4. The device according to claim 1, wherein the carriages of the drive columns comprise drive belt clampings for a drive belt.

5. The device according to claim 1, wherein each individual tension-compression strut of a drive column can be moved individually in the vertical direction within its own guide rail with its own independently vertically movable carriage.

6. The device according to claim 1, wherein the welding head is held by a support plate, which is arranged parallel to the workpiece support for the product to be manufactured, and that between the support plate and the workpiece support a wobble plate is suspended, which enables an axial offset of the welding head.

7. The device according to claim 6, wherein the suspension of the support plate for the welding head from a top plate takes place via an upper coupling socket gripping the fixtures from above and a coupling pin gripping from below.

8. The device according to claim 6 wherein the wobble plate is connected to the support plate via suspensions.

9. The device according to claim 1, wherein the welding head is held between the drive columns by a support plate, which is connected to the drive columns movably in three spatial directions (x, y, z) via further tension-compression struts and revolute joints attached to their ends.

10. The device according to claim 9, wherein the coupling of the tension-compression struts, which can be moved vertically in the drive columns, to the workpiece support or the support plate is effected either from the side or on the upper side or on the underside thereof.

11. The device according to claim 1, wherein a rotation and pivot device is positioned below the support plate for the welding head in order to receive the product to be manufactured in the product receiving area.

12. The device according to claim 1, wherein a nozzle is provided, namely a powder nozzle or a wire nozzle.

13. The device according to claim 1, wherein the welding head is a laser welding head or a soldering head.

14. The device according to claim 1, wherein an additional axially movable milling head is provided for subsequent processing of the workpiece.

15. The device according to claim 1, wherein the support plate is designed to be immovable and the workpiece support is axially movable in the three spatial directions (x, y, z).

16. A method for manufacturing a product by laser cladding, particularly extreme-high-speed laser cladding (EHLA), in which a workpiece support for the product to be manufactured is moved via at least three drive columns in three spatial directions (x, y, z) along a welding head which is arranged parallel to the workpiece support for a product to be manufactured, wherein each drive column allows a path movement of the workpiece support via tension-compression struts connected thereto and a mass compensation via corresponding counterweights.

17. The method according to claim 16, wherein an oscillating operation is applied for creating curves, lines and/or cavities.

18. The method according to claim 16, wherein a support plate for a welding head is arranged above the workpiece support.

19. The method according to claim 18, wherein the support plate is held immovably and the workpiece support is moved individually in the three x, y, z spatial directions.

20. The method according to claim 16, wherein amorphous and/or crystalline material compositions are used for manufacturing the product.
